(19) United States
(12) Patent Application Publication
(10) Pub. No.: US 2013/0106827 A1
(43) Pub. Date: May 2, 2013

(54) METHOD AND CIRCUIT FOR IMPROVING CHARGING OF LIQUID CRYTAL PANEL

(71) Applicants: Deng-Xia Zhao, Guangdong (CN); Yu Wu, Guangdong (CN)

(72) Inventors: Deng-Xia Zhao, Guangdong (CN); Yu Wu, Guangdong (CN)

(21) Appl. No.: 13/377,776

(22) PCT Filed: Nov. 21, 2011
(86) PCT No.: PCT/CN2011/082503

§ 371 Date: Dec. 12, 2011

(30) Foreign Application Priority Data
Oct. 27, 2011 (CN) 201110332302.5

(51) Int. Cl. G09G 5/00

(52) U.S. Cl. 345/212

(57) ABSTRACT

A method and a circuit for improving charging of a liquid crystal panel, the circuit comprises at least one temperature compensated overdrive voltage regulating unit, each of the driving voltage regulating units includes a temperature sensor for detecting a temperature of a liquid crystal panel and outputting a digital value representing the temperature; a reference voltage generator for obtaining a corresponding reference voltage according to the digital value of the temperature; and a voltage regulator for regulating a level of a high output voltage of a gate of the TFT-LCD panel according to the reference voltage. The present disclosure can reduce the cost of a liquid crystal panel and enhance its performance.

### FIELD OF THE INVENTION

The present invention is related to driving a liquid crystal panel and more particularly to a method and a circuit for regulating an overdrive voltage of a liquid crystal panel.

### BACKGROUND OF THE INVENTION

As a temperature of a liquid crystal panel increases or decreases, a viscosity coefficient of a crystal changes as well, its equivalent capacitance also changes, consequently changes will occur in its response time. There are many solutions to tackle the problem with the crystal response speed, among them changing the overdrive (OD) voltage is used the most. A few sets of overdrive voltage tables are stored for acquiring a corresponding overdrive voltage solution by look-up tables according to different temperatures of a liquid crystal panel and other conditions. The existing overdrive voltage regulating solution has the following drawbacks: on one hand, the overdrive voltage tables occupy a storage space of SDRAM which will increase the liquid crystal panel cost; on the other hand, if the overdrive voltage tables are not prepared in details, the overdrive voltage tables will not be able to cover an entire temperature range, thus loopholes will occur and affect the liquid crystal panel performance.

It is obviously that the existing overdrive voltage regulating solutions need to be improved.

### SUMMARY OF THE INVENTION

In order to tackle the technical problems mentioned above, the present invention provides a method and a circuit for improving charging of liquid crystal panel, by which the cost of a liquid crystal panel can be reduced and its performance can be enhanced.

Technical solutions provided by the present invention to tackle the problems mentioned above include providing a method for improving charging of liquid crystal panel, the method includes disposing a temperature compensated overdrive voltage regulating unit at a location corresponding to at least one of disposing locations of the liquid crystal display, the temperature compensated overdrive voltage regulating unit includes a temperature sensor, a reference voltage generator and a voltage regulator, so as to generate a reference voltage according to the sensed temperature by the temperature sensor in real time and automatically regulates a level of a high output voltage output for driving a gate of TFT-LCD panel according to the reference voltage:

A construction of the temperature sensor specifically includes: disposing a first constant current source; disposing a thin film transistor (TFT) on the liquid crystal panel and having it connected to the first constant current source, its gate and drain output a detecting voltage which changes according to the temperature of the liquid crystal panel; disposing an analog and digital converter for converting the detecting voltage into the digital value of the temperature.

The disposition of a construction of the reference voltage generator specifically includes: disposing a second constant current source; disposing an analog and digital converter and having it connected to the second constant current source, a corresponding reference voltage is obtained according to the inputted digital value of the temperature.

The disposition of a construction of the voltage regulator specifically includes: disposing a comparator, having one of its input ends connected to the reference voltage, and its another input end connected to a feedback voltage of the high output voltage for driving a gate of the TFT-LCD panel; disposing a regulator, having its input end connected to an output end of the comparator, its output is the high output voltage level for driving a gate of the TFT-LCD panel.

Preferably, the temperature compensated overdrive voltage regulating units are disposed on different locations of the liquid crystal panel respectively, in order to improve charging of the liquid crystal panel at different locations.

The technical solutions provided by the present invention to tackle the problems mentioned above further include providing a circuit for improving charging of liquid crystal panel, the circuit comprises at least one temperature compensated overdrive voltage regulating unit, each of the temperature compensated overdrive voltage regulating units includes:

a temperature sensor for detecting a temperature of a liquid crystal panel and outputting a digital value representing the temperature;

a reference voltage generator for obtaining a corresponding reference voltage according to the digital value of the temperature; and

a voltage regulator for regulating a level of a high output voltage for driving a gate of the TFT-LCD panel according to the reference voltage.

Comparing with the existing techniques and according to a method and a circuit for improving charging of liquid crystal panel, by detecting a temperature of a liquid crystal panel, a reference voltage is automatically generated according to a value of the temperature, and regulating of a high output voltage (VGH) level for driving a gate of the TFT-LCD panel can be achieved automatically by using the reference voltage, thereby a charging current of the TFT can be changed in order to improve the response time of crystals. As a result, the cost of the liquid crystal panel is reduced and its performance is enhanced.

### BRIEF DESCRIPTION OF THE DRAWINGS

FIG. 1 is a structural diagram of a circuit for improving charging of liquid crystal panel according to the present invention.

### DETAILED DESCRIPTION OF THE INVENTION

The present invention will become more fully understood by reference to the following detailed description of a preferred embodiment thereof when read in conjunction with the attached drawings.

According to a method for improving charging of liquid crystal panel of the present invention, a liquid crystal panel is disposed with a temperature compensated overdrive voltage regulating unit at a location corresponding to at least one of disposing locations of the liquid crystal display. The temperature compensated overdrive voltage regulating unit includes a temperature sensor, a reference voltage generator and a voltage regulator, so as to generate a reference voltage according to the sensed temperature by the temperature sensor in real time and automatically regulates a level of a high output voltage output for driving a gate of TFT-LCD panel according to the reference voltage.

Preferably, the temperature compensated overdrive voltage regulating units disposed on different locations of the liquid crystal panel respectively, in order to improve charging of the liquid crystal panel at different locations, thus it can effectively prevent a problem of insufficient charging caused by different RC delays in different areas of the liquid crystal panel.

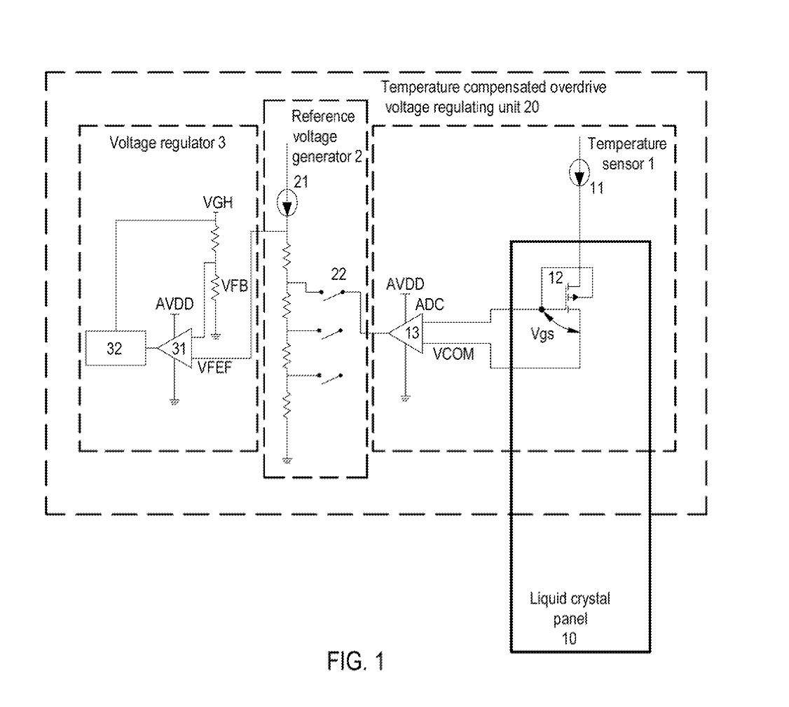

Referring to FIG. 1, it shows a structural diagram of a circuit embodied by using of a method for improving charging of liquid crystal panel of the present invention. It comprises disposing at least one temperature compensated overdrive voltage regulating unit 20 on a liquid crystal panel 10, and each of the temperature compensated overdrive voltage regulating units 20 mainly includes: a temperature sensor 1 for detecting a temperature of the liquid crystal panel 10 and outputting a digital value representing the temperature; a reference voltage generator 2 for obtaining a corresponding reference voltage according to the digital value of the temperature; and a voltage regulator 3 for regulating a level of a VGH according to the reference voltage.

The temperature sensor 1 specifically includes: a first constant current source 11 for providing a constant current I1; a thin film transistor (TFT) 12 disposed on the liquid crystal panel 10 and connected to the first constant current source 11, its gate and drain output a detecting voltage Vgs which changes according to a temperature of the liquid crystal panel; and an analog and digital converter 13 for converting the detecting voltage Vgs into a digital value of the temperature. It should be noted that, in the TFT, its threshold voltage Vth is a function of the temperature, it can be briefly expressed as: Vth=Vth0+aT, Vth0 is a threshold voltage value under a room temperature, a is a temperature coefficient. Accordingly, when the room temperature changes, the corresponding detecting voltage Vgs also changes because the current flowing through the TFT is fixed as the constant current I1.

The reference voltage generator 2 specifically includes: a second constant current source 21 for providing a constant current I2; an analog and digital converter 22 connected to the second constant current source 21, a corresponding reference voltage VREF can be obtained according to the inputted digital value of the temperature. It should be noted that, the analog and digital converter 22 can be composed of a resistance network which is regulated digitally. Accordingly, different digital values of temperatures correspond to different equivalent resistances. Because the current flowing through the equivalent resistances is fixed as the constant current I2, thus the corresponding reference voltage VREF changes automatically without having to transfer tables for a look-up process.

The voltage regulator 3 specifically includes: a comparator 31, one of its input ends is connected to the reference voltage VREF, and its another input end is connected to a feedback voltage VFB of the VGH; a regulator 32, its input end is connected to an output end of the comparator 31, its output is the level of VGH which has been temperature compensated.

Comparing to the conventional techniques and according to a method and a circuit for improving charging of liquid crystal panel of the present invention, by disposing of the temperature compensated overdrive voltage regulating units 20, a crystal response speed can be enhanced correspondingly, and pictures may show more smooth and motion blur of the pictures can be reduced to a certain degree.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A method for improving charging of liquid crystal panel, comprising:
disposing a temperature compensated overdrive voltage regulating unit at a location corresponding to at least one of disposing locations of the liquid crystal display, the temperature compensated overdrive voltage regulating units includes a temperature sensor, a reference voltage generator, and a voltage regulator, so as to generate a reference voltage according to a sensed temperature by the temperature sensor in real time and automatically regulates a level of a high output voltage output for driving a gate of the liquid crystal panel according to the reference voltage.

2. The method as claimed in claim 1, wherein a construction of the temperature sensor includes:
disposing a first constant current source;
disposing a thin film transistor on the liquid crystal panel and having it connected to the first constant current source, a gate and a drain of the thin film transistor output a detecting voltage which changes according to the temperature of the liquid crystal panel; and
disposing an analog and digital converter for converting the detecting voltage into a digital value of the temperature.

3. The method as claimed in claim 1, wherein the disposing of a construction of the reference voltage generator includes:
disposing a second constant current source; and
disposing an analog and digital converter and having it connected to the second constant current source, a corresponding reference voltage is obtained according to the inputted digital value of the temperature.

4. The method as claimed in claim 1, wherein the disposing of a construction of the voltage regulator includes:
disposing a comparator, having one of its input ends connected to the reference voltage, and its another input end connected to a feedback voltage of the high output voltage for driving the gate of the liquid crystal panel; and
disposing a regulator, having its input end connected to an output end of the comparator, its output is the level of the high output voltage for driving the gate of the liquid crystal.

5. The method as claimed in claim 1, wherein the temperature compensated overdrive voltage regulating units are disposed on different locations of the liquid crystal panel respectively, to enhance a charging of the liquid crystal panel at different locations.

6. A circuit for improving charging of a liquid crystal panel, comprising at least one temperature compensated overdrive voltage regulating unit, each of the temperature compensated overdrive voltage regulating units includes:
a temperature sensor for detecting a temperature of a liquid crystal panel and outputting a digital value representing the temperature;
a reference voltage generator for obtaining a corresponding reference voltage according to the digital value of the temperature; and
a voltage regulator for regulating a level of a high output voltage for driving a gate of the liquid crystal panel according to the reference voltage.

7. The circuit as claimed in claim 6, wherein the temperature sensor includes:
a first constant current source;
a thin film transistor disposed on the liquid crystal panel and connected to the first constant current source, a gate and a drain of the thin film transistor output a detecting voltage which changes according to the temperature of the liquid crystal panel;
an analog and digital converter for converting the detecting voltage into the digital value of the temperature.

8. The circuit as claimed in claim 6, wherein the reference voltage generator includes:
a second constant current source; and
an analog and digital converter connected to the second constant current source, and the corresponding reference voltage is obtained according to the inputted digital value of the temperature.

9. The circuit as claimed in claim 6, wherein the voltage regulator includes:
a comparator, one of its input ends is connected to the reference voltage, and its another input end is connected to a feedback voltage of the high output voltage for driving the gate of the liquid crystal panel; and
a regulator, its input end is connected to an output end of the comparator, its output is the level of the high output voltage for driving the gate of the liquid crystal panel.

10. The circuit as claimed in claim 6, wherein a plurality of the temperature compensated overdrive voltage regulating units disposed on different locations of the liquid crystal panel respectively, to enhance a charging of the liquid crystal panel at different locations.
